(19) United States
(12) Patent Application Publication
(10) Pub. No.: US 2015/0207765 A1
(43) Pub. Date: Jul. 23, 2015

(54) Messaging Service with Conversation Suggestions

(71) Applicants: Nathaniel Brantingham, Spokane, WA (US); Jeremy Walsh, Spokane, WA (US); Bryan Smith, Cheney, WA (US)

(72) Inventors: Nathaniel Brantingham, Spokane, WA (US); Jeremy Walsh, Spokane, WA (US); Bryan Smith, Cheney, WA (US)

(21) Appl. No.: 14/598,912

(22) Filed: Jan. 16, 2015

Related U.S. Application Data
(60) Provisional application No. 61/928,876, filed on Jan. 17, 2014.

(51) Int. Cl. H04L 12/58

(52) U.S. Cl. CPC H04L 51/046; H04L 51/16

(57) ABSTRACT

A messaging service may enhance communication between users by providing conversation suggestions. In some implementations, the messaging service may enable users to communicate with each other in a back-and-forth manner. As the users communicate, the messaging service may provide suggestions regarding conversation ideas that may be of interest for the users to discuss. The suggestions may be based on conversation metrics, a comparison of user profiles for the users, and a variety of other information.

### RELATED APPLICATIONS

This application claims priority to U.S. Provisional Patent Application No. 61/928,876, filed on Jan. 17, 2014 and entitled “Messaging Service with Conversation Suggestions,” the entire contents of which are incorporated herein by reference.

### BACKGROUND

Users often employ a messaging service to communicate, such as instant messaging, text messaging, or another online chat service. In many instances, a user provides input into a user interface that is presented on the user's client device and sends the input to a client device of another user that is located remotely to the user. The other user may respond in similar fashion by providing input through a user interface that is presented on the other user's client device. As such, the users may communicate in real-time in a back-and-forth manner. In many instances, the users of these conversations become disinterested in the conversations and leave the conversations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which the techniques described herein may be implemented.

FIG. 2 illustrates an example conversation user interface that displays a conversation suggestion in a pre-formed format for a conversation.

FIG. 3 illustrates an example conversation user interface that displays multiple conversation suggestions in a drop-down menu.

FIG. 4 illustrates an example process for employing the techniques described herein.

### DETAILED DESCRIPTION

This disclosure describes a messaging service that enhances communication between users. In some implementations, the messaging service may enable users to communicate with each other in a back-and-forth manner. The users may send messages that include text, audio, video, images, links, or other content to facilitate a conversation. As the users communicate, the messaging service may provide suggestions regarding conversation ideas that may be of interest to the users. The suggestions may assist the users in moving the conversation forward in a meaningful manner.

A suggestion may be based on various types of information. In some instances, a suggestion may be based on one or more user profiles of users that are communicating. A user profile may indicate interests of a user, preferences of a user, characteristics about a user, conversation metrics, and so on. The user profile may be created by a user or formed from an analysis of information about that user (e.g., posts to social networking sites, blogs, etc.). Alternatively, or additionally, a user profile may be created by monitoring a conversation. A user profile may be used and/or generated with the user's explicit consent. In some instances, a user profile may not be made available to a particular user or system. For example, a user profile of a first user that is utilizing the messaging service may be inaccessible to a second user that is utilizing the messaging service. This may encourage users to provide information for a profile. In another example, a user profile of a user may not be made available to the user.

In some instances, a suggestion may be based on a topic that is deemed to be of interest to the users, particular types of users, or the population in general (e.g., predetermined or generic topics, topics identified through analyzing user information, etc.). Moreover, in some instances a suggestion may be based on a conversation history for a user (e.g., suggest that a user discusses baseball when another user has talked about baseball in the past, either with the same user of the current conversation or a different user). In yet other instances a suggestion may be based on an advertisement (e.g., “consider talking about the new restaurant that has opened in town”).

The messaging service may cause a suggestion to be present when a suggestion event has occurred. In many instances, the messaging service may analyze conversation metrics to determine when such an event has occurred. In one example, the suggestion event may occur when it is determined that a period of inactivity has occurred during which a user has not engaged in a conversation. In another example, the suggestion event may occur when it is determined that a predetermined word, phrase, emoticon, or other content has been used during the conversation or used more than a predetermined number of times.

In one illustration of the messaging service described herein, assume that a first user is communicating with a second user through the messaging service. The first and second users may each interact with a conversation interface on a respective computing device through touch, text, voice, gesture, or another type of input. As the users communicate, the messaging service may identify a break or lull in the conversation (e.g., a period of inactivity in the conversation). The messaging service may then determine that the first user and the second user are both interested in snow skiing based on user profiles for the first and second users. Accordingly, the messaging service displays a suggestion to talk about snow skiing (e.g., “Consider talking about snow skiing,” “You might bring up the winter Olympics,” etc.). For example, the suggestion may be presented through the conversation interface associated with the first user as an icon or other type of interface element (e.g., pop-up box, widow, etc.). The first user may adopt the suggestion and input text to discuss snow skiing.

In some instances, a suggestion may be pre-formed for a conversation. That is, the suggestion may contain substantially what a user should input. For example, the suggestion may include an icon that includes text “Have you been skiing lately?” Here, the user may select the icon and the text “Have you been skiing lately?” may be input as text for the user to send to the other user. In this example, a message that is provided to the other user may be marked as being associated with a suggestion (e.g., a flag or other information indicating that the text was based on a suggestion from the messaging service). In other examples, the message may not be marked as having an association to a suggestion.

In other instances, a suggestion may not be pre-formed for a conversation. For example, the messaging service may provide information about a topic to a user without providing the particular text for the user to input. The user may formulate a message to send to the other user based on the suggestion (e.g., in response to a suggestion to “talk about music,” the user may formulate and send a message stating “I'm planning on going to a concert next month, are you interest in going?”).

In some instances, a suggestion may include a comment regarding a user's messaging style. For example, the messaging service may provide a comment regarding content of a message or how to respond to a message (e.g., “consider providing more text per message,” “consider asking more follow-up questions,” “consider responding more quickly,” “generally people respond better to more emotional phrases, such as ‘I love ice cream . . . , ’” “you might talk more about your feelings on politics,” etc.).

Additionally, or alternatively, in some implementations the messaging service may recommend a user for another user to communicate with (e.g., identify a new contact). For example, based on user profiles, user locations, or other types of information, the messaging service may identify users that have common characteristics and recommend that those users communicate. In one example, a recommendation of a user may be made to another user while the other user is browsing through contacts of the user's device (e.g., outside a conversation interface). To illustrate, the messaging service may cause a text box to appear on a contact screen that states “Would you like us to find someone for you to talk to?” If the user indicates a desire to talk, the messaging service may generate a recommendation based on user profiles, user locations, or other types of information.

Further, in some implementations the messaging service may provide feedback to users about conversations (e.g., through a conversation interface or otherwise). The feedback may include a status of the conversation (e.g., whether the conversation is active (users are responding) or inactive (stalled—users are not responding)), health information about the conversation (e.g., how quickly users are replying to messages, if suggestions are leading to meaningful conversations, how in depth topics are discussed, whether or not a conversation is changing from topic-to-topic, etc.), or a conversation metric (e.g., word counts per message or overall, number of messages sent or read, etc.).

For discussion purposes, some example implementations are described below with reference to the corresponding figures. However, implementations herein are not limited to the particular examples provided, and may be extended to other environments, other system architectures, other types of merchants, and so forth, as will be apparent to those of skill in the art in light of the disclosure herein.

### Example Architecture

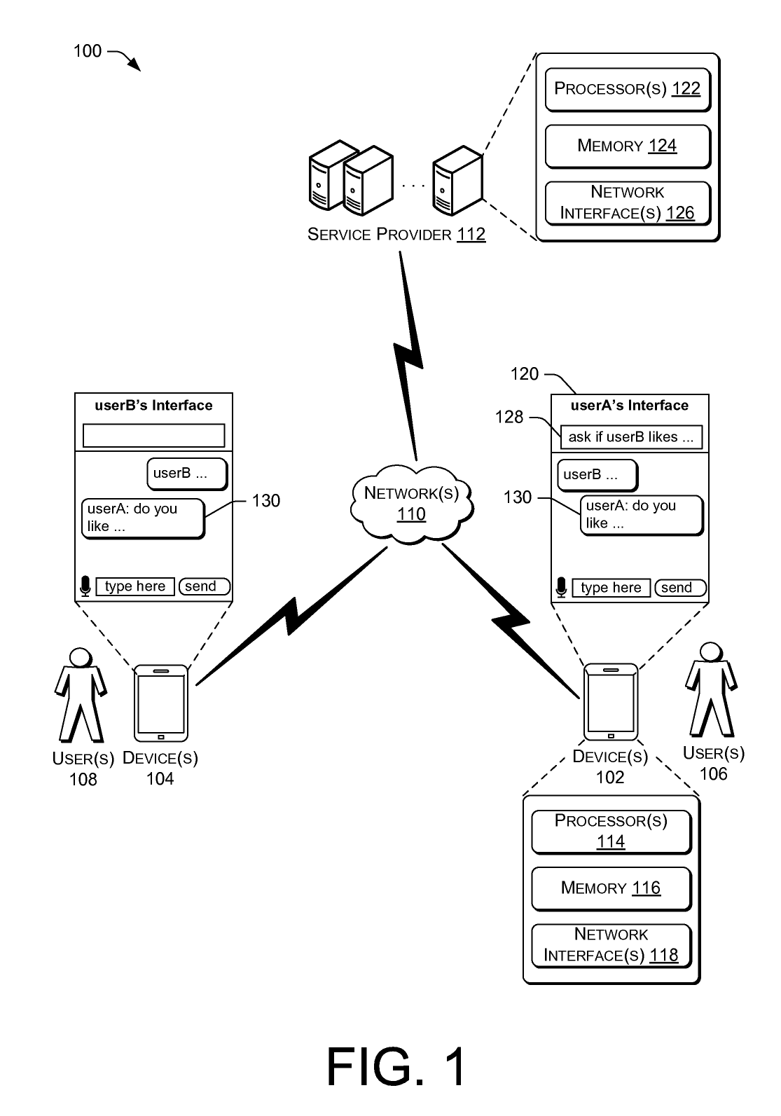

FIG. 1 illustrates an example architecture 100 in which the techniques described herein may be implemented. The architecture 100 includes one or more computing devices 102 (hereinafter “the device 102”) configured to communicate with one or more computing devices 104 (hereinafter “the device 104”). The device 102 may be associated with one or more users 106 (hereinafter “the user 106”), while the device 104 may be associated with one or more users 108 (hereinafter “the user 108”). The device 102 may communicate with the device 104 via one or more networks 110. In this example, the device 102 communicates with the device 104 with the assistance of a service provider 112. The service provider 112 may generally implement a messaging service to manage communications between the device 102 and the device 104 to enable the user 106 and the user 108 to carry out a conversation or otherwise exchange information. For example, the service provider 112 may relay input received at the device 102 to the device 104. The device 102, the device 104, and/or the service provider 112 may communicate via the one or more networks 110.

The device 102 is representative of each of the devices 102 and 104. The device 102 may comprise any type of computing device that is configured to perform an operation. For example, the device 102 may be implemented as a laptop computer, a desktop computer, a server, a smart phone, an electronic reader device, a mobile handset, a personal digital assistant (PDA), a portable navigation device, a portable gaming device, a tablet computer, a wearable computer (e.g., a watch, a pair of glass with computing capabilities, etc.), a portable media player, a television, a set-top box, a computer system in a car, an appliance, a camera, a robot, a hologram system, a security system, a home-based computer system (e.g., intercom system, home media system, etc.), a projector, an automated teller machine (ATM), and so on. In one example, the device 102 may comprise a mobile device.

The device 102 may be equipped with one or more processors 114, memory 116, and one or more network interfaces 118. The device 102 may also include one or more cameras, one or more displays, one or more microphones, one or more speakers, and/or one or more sensors. These components may be communicatively coupled to the one or more processors 114. The one or more processors 114 may include a central processing unit (CPU), a graphics processing unit (GPU), a microprocessor, a digital signal processor, and so on. The one or more cameras may include a front facing camera and/or a rear facing camera. The one or more displays may include a touch screen, a Liquid-crystal Display (LCD), a Light-emitting Diode (LED) display, an organic LED display, a plasma display, an electronic paper display, or any other type of technology. The one or more sensors may include an accelerometer, compass, gyroscope, magnetometer, Global Positioning System (GPS), olfactory sensor (e.g., for smell), or other sensor.

In some instances, the messaging service may be implemented, at least in part, by a client application that may be stored in the memory 116 of the device 102. The client application may generally facilitate a conversation interface 120 to enable the user 106 to communicate with other users. For example, the client application may receive input or other messages from the user 106, output messages or other content to the user 106, provide suggestions to a conversation, and perform a variety of other functions. In some instances, the client application enables a group conversation between multiple users. The client application may be implemented as, or in association with, a mobile application, desktop application, a browser (e.g., mobile or desktop browser), and so on.

In one example, the messaging service may be implemented as a text messaging service. In another example, the messaging service may be implemented as an instant messaging service (e.g., an online chatting service). In yet another example, the messaging service may be implemented as another type of real-time conversation service. Any number of users may communicate via the messaging service. In one example, two or more users communication in a single conversation.

As noted above, the messaging service may be implemented in cooperation with the service provider 112. The service provider 112 may include one or more computing devices. The one or more computing devices may be implemented as one or more desktop computers, laptop computers, servers, and so on. The one or more computing devices may be configured in a cluster, data center, cloud computing environment, or a combination thereof. In one example, the service provider 112 provides cloud computing resources, including computational resources, storage resources, networking resources, and the like, that operate remotely to the device 102 and/or the device 104.

The one or more computing devices of the service provider 112 may be equipped with one or more processors 122, memory 124, and one or more network interfaces 126. The memory 124 and/or one or more network interfaces 126 may be communicatively coupled to the one or more processors 122. The one or more processors 122 may include a central processing unit (CPU), a graphics processing unit (GPU), a microprocessor, a digital signal processor, and so on.

The service provider 112 may manage communications between the device 102 and the device 104. The service provider 112 may also determine or select suggestions to be provided to users. In some instances, a suggestion is identified based on information associated with a user of a conversation (e.g., user profile, conversation history, etc.). That is, the service provider 112 may identify a topic or content that may be of interest to a user of a conversation. In other instances, a predetermined topic that is generally applicable to a variety of users may be provided as a suggestion. In yet other instances, a suggestion may include an advertisement. In further instances, a suggestion may include other types of information. In some examples, a suggestion may be made available to a user when a fee is provided by the user (e.g., paid suggestion), while in other examples a suggestion may be provided free of charge. The service provider 112 may also collect and manage information about users (e.g., to build user profiles), generate and provide recommendations that identify users to communicate with, generate and provide feedback about conversations (e.g., status or health conversation information, conversation metrics, etc.), and perform a variety of other functionality described herein. Further, the service provider 112 may facilitate games between users to assist the users in getting to know each other (e.g., conversation games). For example, the service provider 112 may prompt a user to play a game where the user guesses a favorite of another user (e.g., “Guess his favorite band”). The users might be scored based on how many questions they answer correctly or based on how they communicate. A game may be useful as, for example, an icebreaker for a conversation, an orientation class, a group conversation, and so on.

The service provider 112 may include a data store (e.g., a database), not illustrated, to store a variety of information related to conversations, users, and so on. For example, the data store may include:
Conversation information, such as conversation or chat history (e.g., current or previous conversations of users).
User profiles. The service provider 112 may manage user profiles by creating and updating the user profiles as information is collected. In some instances, the service provider 112 may provide questions or comments to prompt a user for input about a user profile (e.g., while in a conversation interface or profile setting interface asking “What did you do over the weekend?”). Here, the user may provide responses to update the user profile. The service provider 112 may prompt a user for profile information when it is determined that profile information is missing. In other instances, a user profile may be automatically generated from an analysis of user information (e.g., social networking sites, blogs, conversation information, etc.). A user profile may indicate user interests (e.g., skiing, cars, food, likes, dislikes, etc.), characteristics (e.g., gender, height, weight, age, location (geo-location, mailing address, etc.), preferences (e.g., purchasing preferences, eating preferences, etc.), conversation metrics (e.g., number of messages sent or read or other measurable data), and so on. In some instances, a user profile may be modified as more information is collected from conversations or otherwise.
Conversation suggestions. In some instances, a general list of predetermined or generic conversation suggestions may be stored in the data store. For example, the data store may include a conversation suggestion to talk about a new type of fitness program that has been discussed frequently on health blogs (e.g., more than a threshold number of times). Additionally, or alternatively, the data store may include a list of conversation suggestions that are targeted to a particular user, type of user, or conversation. For example, a particular user may be associated with a list of conversation suggestions that are specific to topics that the user has discussed. Moreover, in some instances the data store may include a list of conversation suggestions that are related to an advertisement (e.g., “consider talking about the local AMC® movie theater”). A conversation suggestion may identify or include a topic, subject matter, news issue, current event, question, social media post, song, movie, picture, or any other information or content.
Conversation metrics, such as word counts per message or overall, delay in sending a reply message (e.g., amount of time from receiving a message to sending a reply message—which indicates how quickly a user is responding), number of messages sent or read (e.g., for a particular conversation, topic, or overall), number of messages sent or read within a window of time or from a message that initiates a conversation, number of words or phrases repeated over a period of time, number of emoticons used over a period of time, or other measurable data.
Information about a status or health of a conversation. The status or health of the conversation may be based on conversation metrics. A status of a conversation may indicate whether the conversation is active (users are responding or sending more than a particular number of messages) or inactive (stalled—users are not responding or not sending more than a particular number of messages). The status may be a binary value (e.g., yes or no) or a value on a scale (e.g., 1-10). A health of a conversation may indicate how quickly users are replying to messages, if suggestions are leading to meaningful conversations (e.g., based on the users continuing to discuss a suggested topic, based on a number of messages, etc.), how in depth topics are discussed (e.g., based on a number of messages about a topic), whether or not a conversation is changing from topic-to-topic, whether or not users are responding to messages, whether or not substantive replies are being sent, slang usage in the conversation, types of emoticons used in the conversation, tone of messages sent or read, and so on. Any of the conversation metrics or information about the status or health of a conversation may indicate a messaging style of the user.
Etc.

Although the service provider 112 is discussed as implementing the messaging service, in some instances the service provider 112 may be eliminated. In one example, the device 102 and the device 104 may communicate directly with one another (e.g., in a peer-to-peer context), or over a network, without the assistance of the service provider 112. As such, the device 102 and the device 104 may implement the messaging service without the service provider 112.

The memory 116 and/or 124 (as well as all other memory described herein) may include one or a combination of computer-readable storage media. Computer-readable storage media includes volatile and non-volatile, removable and non-removable media implemented in any method or technology for storage of information, such as computer readable instructions, data structures, program modules, or other data. Computer-readable storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer-readable storage media does not include communication media, such as modulated data signals and carrier waves. As such, computer-readable storage media is non-transitory media.

In some instances the techniques described herein may be implemented as software functionality configured as one or more “modules” that are stored in memory and executable by one or more processors. For example, one or more modules may be stored in the memory 124 and executed by the one or more processors 122. In another example, one or more modules may be stored in the memory 116 and executed by the one or more processors 114. The term “module” is intended to represent example divisions of the software for purposes of discussion, and is not intended to represent any type of requirement or required method, manner or necessary organization.

Further, in some instances the techniques described herein may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

As noted above, the architecture 100 may also include the one or more networks 110 to enable the device 102, the device 104, and/or the service provider 112 to communicate with each other. The one or more networks 110 may include any one or combination of multiple different types of networks, such as cellular networks, wireless networks, Local Area Networks (LANs), Wide Area Networks (WANs), the Internet, and so on.

In one example of the architecture 100, the messaging service may facilitate a conversation between the user 106 and the user 108. Here, the users 106 and 108 may communicate using text input, although any type of input may be used. In this example, the messaging service identifies an interest of the user 108 (e.g., the user likes snow skiing) based on an analysis of a user profile of the user 108. The service provider 112 may also identify that the user 106 is interested in snow skiing based on an analysis of a user profile of the user 106. That is, the service provider 112 may identify information that is common to the user 108 and the user 106. Accordingly, a suggestion 128 is presented to the user 106 indicating that the user 106 should ask if the user 108 likes snow skiing. The user 106 adopts the suggestion and asks if the user 108 is interested in snow skiing, as illustrated by an icon 130.

### Examples Interfaces

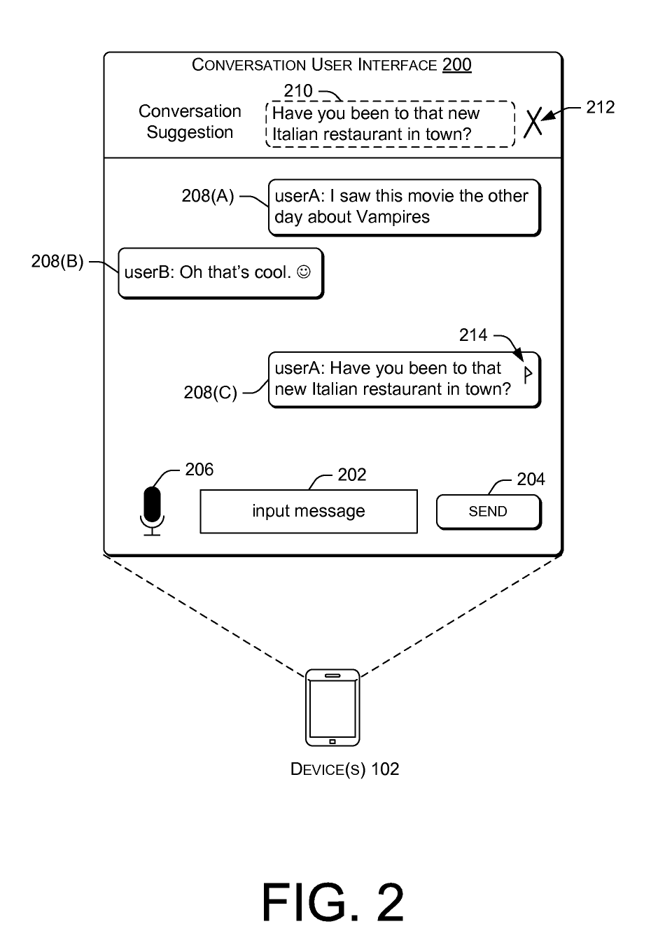

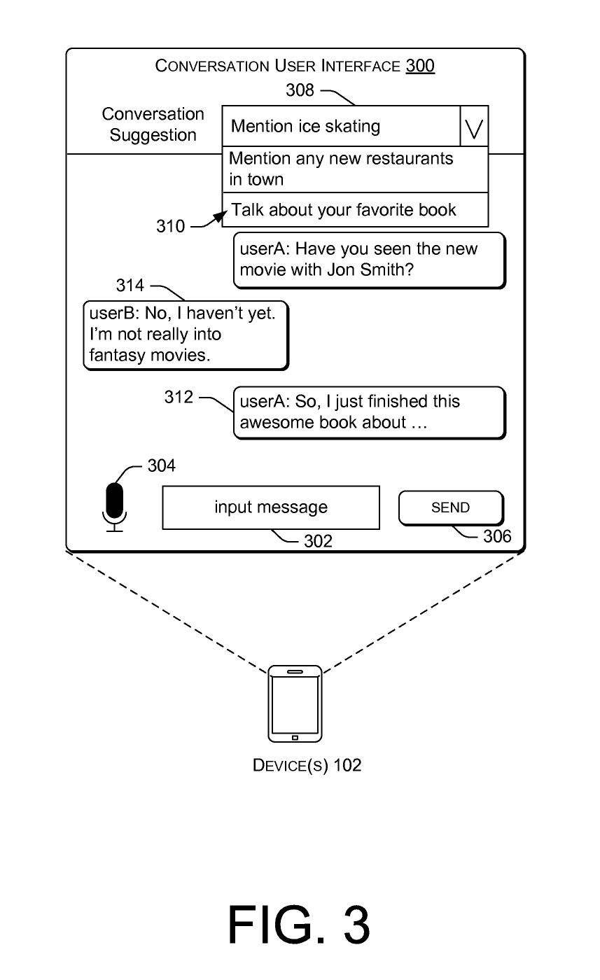

FIGS. 2 and 3 illustrate examples conversation user interfaces that may be presented to a user to facilitate the messaging service discussed herein. The conversation user interfaces may be displayed via a browser, an application (e.g., client application), and so forth. Although illustrated as being presented via the device 102, the conversation user interfaces may be presented via other devices, such as the device 104. Further, any conversation suggestions that are illustrated in the conversation user interfaces may alternatively, or additionally, be presented via other types of user interfaces.

FIG. 2 illustrates an example conversation user interface 200 that displays a conversation suggestion in a pre-formed format for a conversation. As illustrated, the conversation user interface 200 includes an input field 202 to enable a user (“userA” in this example) to provide input and a send button 204 to enable the user to sent the input as a message to another user (“userB” in this example). The conversation user interface 200 also includes a microphone icon 206 to enable the user to provide audio input. The user may communicate in a back-and-forth manner with the other user by providing various types of input or content. As shown, the conversation between the users may be illustrated with various conversation items 208 (e.g., conversation icons or bubbles showing the messages of the users).

In this example, the conversation user interface 200 presents a conversation suggestion 210 when it is determined that there is a break or lull in the conversation. Here, the service provider 112 has determined that a period of inactivity has occurred in the conversation after a message associated with the conversation item 208(B) is received. Further, based on content of the message associated with the conversation item 208(B) (“Oh that's cool. [symbol] ”), the service provider 112 determines that the other user is disinterested in the conversation. Thus, a conversation suggestion 210 is presented via the conversation user interface 200 to further the conversation.

As illustrated, the conversation suggestion 210 is provided in a pre-formed format. That is, the conversation suggestion 210 is formatted to be inserted into the conversation without modification to the text of the conversation suggestion 210, or without substantial modification to the text. In this example, the conversation suggestion 210 is associated with a marker 212 indicating whether or not the conversation suggestion 210 has been used in the past (either in this conversation or a different conversation). In this example, the conversation suggestion 210 has not been used, as illustrated by the “X.”

The user may select the conversation suggestion 210 (e.g., the icon), and the conversation suggestion 210 may be inserted into the conversation and sent to the other user as a message, as illustrated by the conversation item 208(C). The conversation item 208(C) includes a marker 214 (e.g., flag or other indicator) indicating that the message is based on a suggestion. The marker 214 may be displayed to the user, the other user with whom the user is communicating, or both.

FIG. 3 illustrates an example conversation user interface 300 that displays multiple conversation suggestions in a drop-down menu. Similar to the conversation user interface 200 of FIG. 2, the conversation user interface 300 includes an input field 302, a microphone icon 304, and a send button 306 to carry out a conversation with another user.

In this example, the conversation user interface 300 includes a drop-down menu 308 with multiple conversation suggestions. The multiple conversation suggestions may be accessed at any time during the conversation, such as when the user feels that the other user is becoming disinterested in the conversation. In some instances, the multiple conversation suggestions are updated as the conversation progresses, while in other instances the multiple conversation suggestions may be predefined and may not update. Here, the multiple conversation suggestions indicate topics to discuss, so that the user may form a message to the other user. In this example, the user has referenced a conversation suggestion 310 to formulate a message associated with a conversation item 312. In particular, the user noticed that the other user became disinterested in the conversation due to a message associated with a conversation item 314, “No, I haven't yet. I'm not really into fantasy movies.” Accordingly, the drop-down menu 308 was selected and the conversation suggestion 310 was used.

Although the drop-down menu 308 is used in FIG. 3 to illustrate multiple conversation suggestions, in other instances multiple conversation suggestions may be presented in other manners, such as displaying conversation suggestions in a moving format on an icon (e.g., as moving from right-to-left, top-to-bottom, etc.).

### Example Process

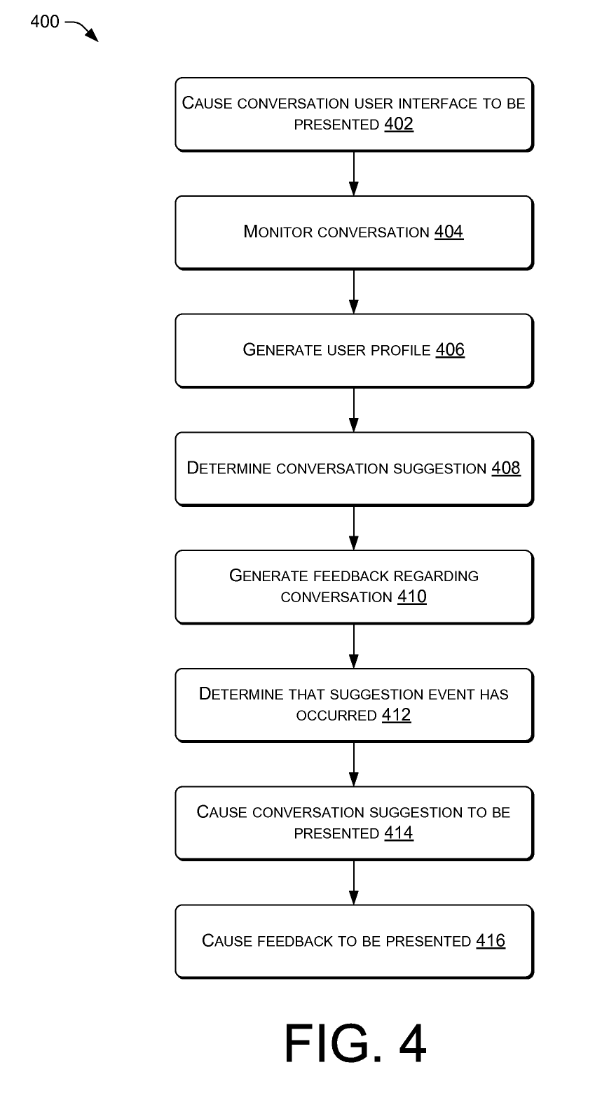

FIG. 4 illustrates an example process 400 for employing the techniques described herein. For example, the process 400 may determine a suggestion to provide during a conversation between users. For ease of illustration, the process 400 is described as being performed in the architecture 100 of FIG. 1. For example, one or more of the operations of the process 400 may be performed by the device 102, the device 104, and/or the service provider 112. However, the process 400 may be performed in other architectures. Moreover, the architecture 100 may be used to perform other processes.

The process 400 (as well as each process described herein) is illustrated as a logical flow graph, each operation of which represents a sequence of operations that can be implemented in hardware, software, or a combination thereof. In the context of software, the operations represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the described operations may be omitted.

At 402, the service provider 112 may cause a conversation user interface to be presented via the device 102 and/or the device 104 to facilitate a conversation between the user 106 and the user 108. This may include sending information to the device 102 and/or the device 104 so that a user interface is displayed on the respective device.

In some instances, the service provider 112 may send a recommendation to initiate a conversation with a particular user. For example, the service provider 112 may analyze a user profile associated with the user 106 to identify another user that has a threshold amount of similarity to the user 106 (e.g., shares a particular number of common interests). The service provider 112 may then send a recommendation to the user 106 recommending that the user 106 have a conversation with the other user. This may enable the user 106 to identify other users that may be of interest for a conversation.

At 404, the service provider 112 may monitor the conversation between the user 106 and the user 108. The monitoring may generally include collecting information about messages or other content that is sent between the user 106 and the user 108 during the conversation. The monitoring may additionally, or alternatively, include evaluating a user's use of the messaging service implemented by the service provider 112 (e.g., determining whether a messaging application is open and in use, etc.). The monitoring may be performed with the explicit consent of the user 106 and/or the user 108. For example, a message may be displayed as the conversation begins to request permission to monitor information exchanged between the user 106 and the user 108.

At 406, the service provider 112 may generate a user profile for a user, such as the user 106 and/or the user 108. A user profile may indicate interests of a user, preferences of a user, characteristics about a user, conversation metrics, and so on. In some instances, a user profile may be specific to a conversation, a particular user, a particular type of user, and so on. To illustrate, a user profile for the user 106 may indicate that the user 106 generally (e.g., more than a particular number of times) discusses sports when talking to males and generally discusses cooking when talking to a particular user. In other instances, a user profile may be more general (e.g., indicate information for a user across conversations).

In some instances, a user profile may be inaccessible to any number of users or systems. For example, a user profile associated with the user 106 may be inaccessible to other users to encourage the user 106 to provide as much information as possible for the user profile. Alternatively, or additionally, the user profile for the user 106 may be inaccessible to the user 106. That is, the user profile may be hidden from the user 106. Here, the user profile may be created on the back-end without the user knowing the specific information that is being collected during the conversation. Moreover, in some instances a user may have multiple types of user profiles, such as one which is inaccessible to the user and other users, one which is accessible to the user and inaccessible to other users, and one which is accessible to all users. The different types of user profiles may include different types of information.

A user profile may be generated in a variety of manners at 406. In some instances, a user profile is generated based on the monitoring of the operation 404. Here, the user profile may include information that is learned about how a user communicates through the messaging service of the service provider 112 (e.g., how has the user responded to particular types of questions, what are some typically responses, etc.). For example, based on messages or other content that is communicated during a conversation, the service provider 112 may identify one or more interests, characteristics, or preferences of a user and store information about those interests, characteristics, or preferences in a user profile. Similarly, the service provider 112 may determine conversation metrics based on the monitoring at 404 (e.g., how many words are used per minute, amount of text provided per message, etc.) and store those conversation metrics in a user profile. In some illustrations, the service provider 112 may make inferences about the user's interests, characteristics, or preferences by processing messages or content that are communicated and identifying concepts of the messages or content (e.g., determine that a user is interested in basketball based on a number of references to a particular basketball player). As such, a user profile may indicate a messaging style of a user.

Further, in some instances the service provider 112 may generate a user profile by prompting the user for information, at various times before, during, or after a conversation, and receiving information from a user. For example, if the service provider 112 determines that the user 106 has not provided a threshold amount of information for a user profile, or a threshold amount of information has not otherwise been collected, a recommendation or message may be sent to the user 106 requesting additional information for the user profile. The recommendation or message may be displayed via a conversation user interface or otherwise. Since user profiles may be used to determine a conversation suggestion, a more complete user profile may enable more applicable conversation suggestions to be determined.

Moreover, in some instances a user profile is generated by collecting information from other sources, such as social networking services or other online sources. For example, the service provider 112 may reference a post to a social networking site or blog to identify an interest, characteristic, or preference of a user to be included in a user profile.

At 408, the service provider 112 may determine or generate a conversation suggestion for the conversation between the user 106 and the user 108. A conversation suggestion may include any content to assist in enhancing a conversation. For example, a conversation suggestion may indicate a topic to discuss during a conversation (e.g., “Consider talking about a basketball team,” “Consider mentioning your favorite Italian restaurant,” etc.). In some instances a conversation suggestion includes pre-formed content for a message, so that a user may select the conversation suggestion and place it into the conversation. To illustrate, the conversation user interface may display an icon with text “Have you been skiing lately?” and a user may select the icon to place it directly in the conversation.

In some instances, the service provider 112 may determine or generate a conversation suggestion at 408 by analyzing a user profile associated with the user 106 and/or the user 108. The analysis may identify common information between the users, such as a shared characteristic, preference, interest, and so on. The service provider 112 may then determine a conversation suggestion from the common information. To illustrate, if user profiles of the users 106 and 108 indicate that the users 106 and 108 are both interested in hockey, then the service provider 112 may determine a conversation suggestion that is related to hockey (e.g., “I'm going to the hockey game in a few weeks, do you want to go?” or “Did you see the hockey game last night?”). Here, the conversation suggestion may provide a topic that is deemed to be of interest to the user 106 and/or the user 108.

Further, in some instances a conversation suggestion may be determined based on conversation history for a current or previous conversation. To illustrate, if the user 106 mentions an Italian restaurant in a previous conversation with another user, the service provider 112 may generate a conversation suggestion that mentions Italian food for a conversation the user 108 is having with the user 106 (e.g., “Are you interested in going out to eat at the new Italian restaurant in town?”).

In yet other instances, a conversation suggestion may be determined based on conversation metrics. To illustrate, a conversation metric may be used to identify a messaging style of a user, such as how frequently a user responds, how detailed a user's response are, etc. Based on the user's writing style, and learned information about conversations that are deemed to be positive, the service provider 112 may generate a comment regarding how to enhance the user's messaging style (e.g., “consider providing more text per message,” “consider asking more follow-up questions,” “consider responding more quickly,” “generally people respond better to more emotional phrases, such as ‘I love ice cream . . . , ’” “you might talk more about your feelings on politics,” etc.).

In some examples, at 408, the service provider 112 may select a conversation suggestion from a list of conversation suggestions. A list may include a general list of conversation suggestions that are applicable to a wide variety of users, a targeted list of conversation suggestions that are specific to a user or conversation (e.g., based on user profiles, conversation history, etc.), and/or a list of conversation suggestions related to advertisements. In one illustration, a general list of conversation suggestions may be created based on an analysis of multiple conversations across a wide variety of users. The general list may include, for example, sport-related conversation suggestions, food-related conversation suggestions, work-related conversation suggestions, and so on. In another illustration, a list of conversation suggestions may be created for the user 106 based on interests, characteristics, or preferences of the user 106. This list may be associated with the user 106 and individual conversation suggestions may be provided to other users that are having conversations with the user 106. In a further illustration, a list of conversation suggestions may be created for a specific conversation between the user 106 and the user 108. Here, if the user 106 mentions a musical, the service provider 112 may add a conversation suggestion regarding a play in the local city to a list for the user 108 to ask at an appropriate time, which may be in a future conversation. In yet another illustration, a list of conversation suggestion may be created for advertisements. Here, a conversation suggestion may include advertisement content, such as content that is related to a company that has paid to be mentioned in a conversation (e.g., “Consider mentioning your favorite NBA team,” “You might mention your favorite dish at Olive Garden®,” etc.).

At 410, the service provider 112 may generate feedback regarding the conversation between the user 106 and the user 108. The feedback may be based on the monitoring at 404. The feedback may include a status of the conversation (e.g., whether the conversation is active (users are responding) or inactive (stalled—users are not responding)), health information about the conversation (e.g., how quickly users are replying to messages, if suggestions are leading to meaningful conversations, how in depth topics are discussed, whether or not a conversation is changing from topic to topic, etc.), or a conversation metric (e.g., word counts per message or overall, number of messages sent or read, etc.).

Although illustrated as being included in the process 400 before operation 412, the operation 410 may be performed at any time. In one example, the operation 410 is performed after operation 414.

At 412, the service provider 112 may determine that a suggestion event has occurred based on the monitoring at 404 and/or conversation metrics. In one example, the suggestion event may occur when it is determined that a period of inactivity has occurred during which the user 106 and/or the user 108 have not engaged in the conversation (e.g., have not provided a message over a period of time, have closed or left a messaging application, a sensor or component of a device (magnetometer, accelerometer, camera, touch screen, etc.) indicates that the device has not been used for a period of time, etc.). In another example, the suggestion event may occur when it is determined that a predetermined word, phrase, emoticon, or other content has been used during the conversation (e.g., using just a smiley face to respond to a message, etc.). The predetermined word, phrase, emoticon, or other content may be learned over time as being associated with a break or lull in the conversation. In yet another example, the suggestion event may occur when it is determined that a predetermined word, phrase, emoticon, or other content has been used more than a predetermined number of times within a period of time or overall (e.g., saying “nice” five times within a 3 minute window, using a smiley face six times, etc.).

At 414, the service provider 112 may cause a conversation suggestion to be presented via a conversation user interface. For example, the conversation suggestion may be sent to the device 102 and/or the device 104 to be displayed within a conversation user interface implemented on the device 102 and/or the device 104. The conversation suggestion may be sent in response to determining the occurrence of the suggestion event at 412. In some instances where the conversation suggestion includes pre-formed content, a user may request to use the conversation suggestion and the pre-formed content may be included in the conversation as a message from the user.

At 416, the service provider 112 may cause feedback that is generated at 410 to be presented via a conversation user interface. As noted above, the feedback may include a status of the conversation, health information about the conversation, or a conversation metric. In some instances, the feedback may enable a user to view how the conversation is going or how a previous conversation has gone.

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
causing, by a computing device, a conversation user interface to be displayed via an electronic device to facilitate a conversation between a first user and a second user;
monitoring, by the computing device, the conversation between the first user and the second user;
analyzing, by the computing device, a user profile associated with the first user and a user profile associated with the second user to determine a conversation suggestion, the user profile that is associated with the first user being inaccessible to the second user and the user profile that is associated with the second user being inaccessible to the first user;
determining, by the computing device and based at least in part on the monitoring, that a suggestion event has occurred; and
in response to determining the occurrence of the suggestion event, causing the conversation suggestion to be presented via the conversation user interface.

2. The method of claim 1, wherein the determining that the suggestion event has occurred comprises determining that a period of inactivity has occurred during which at least one of the first user or the second user has not engaged in the conversation.

3. The method of claim 1, wherein the determining that the suggestion event has occurred comprises determining that at least one of a predetermined word, a predetermined phrase, or a predetermined emoticon has been used during the conversation by at least one of the first user or the second user.

4. The method of claim 1, wherein the determining that the suggestion event has occurred comprises determining that at least one of a word, a phrase, or an emoticon has been used more than a predetermined number of times within a period of time during the conversation.

5. The method of claim 1, wherein the conversation suggestion includes advertisement content to be discussed during the conversation.

6. The method of claim 1, further comprising:
generating the user profile that is associated with the first user based at least in part on the monitoring, the user profile that is associated with the first user being inaccessible to the first user.

7. One or more non-transitory computer-readable storage media storing computer-readable instructions that, when executed by one or more processors, instruct the one or more processors to perform operations comprising:
causing a conversation interface to be presented to facilitate a conversation between a user and another user; and
causing a suggestion to be presented to assist at least one of the user or the other user in the conversation, the suggestion being presented via the conversation interface.

8. The one or more non-transitory computer-readable storage media of claim 7, wherein the operations further comprise:
comparing a user profile associated with the user to a user profile associated with the other user to identify common information; and
determining the suggestion based at least in part on the common information.

9. The one or more non-transitory computer-readable storage media of claim 7, wherein the operations further comprise determining the suggestion based at least in part on a topic that is deemed to be of interest to at least one of the user or the other user.

10. The one or more non-transitory computer storage media of claim 7, wherein the operations further comprise determining the suggestion based at least in part on a conversation history for at least one of the user or the other user, the conversation history including information from the conversation or a previous conversation.

11. The one or more non-transitory computer-readable storage media of claim 7, wherein the suggestion includes pre-formed content for a message to at least one of the user or the other user; and the operations further comprise:
in response to receiving a request from the user to use the suggestion, causing the pre-formed content to be sent as a message from at least one of the user or the other user.

12. The one or more non-transitory computer-readable storage media of claim 7, wherein the suggestion is based at least in part on a messaging style of at least one of the user or the other user, the suggestion indicating how to enhance the messaging style.

13. The one or more non-transitory computer-readable storage media of claim 7, wherein the operations further comprise:
sending a message to at least one of the user or the other user based at least in part on the suggestion, the message including a marker indicating that the message is based at least in part on the suggestion.

14. The one or more non-transitory computer-readable storage media of claim 7, wherein the operations further comprise:
generating feedback regarding the conversation, the feedback including at least one of a status of the conversation, health information about the conversation, or a conversation metric; and
causing the feedback to be provided via the conversation user interface.

15. The one or more non-transitory computer-readable storage media of claim 7, wherein the operations further comprise:
analyzing a user profile associated with the user; and
causing a recommendation to be presented to the user regarding the analysis of the user profile, the recommendation recommending at least one of that the user have a conversation with the other user or that the user add information to the user profile.

16. A system comprising:
one or more processors; and
memory communicatively coupled to the one or more processors and storing executable instructions that, when executed by the one or more processors, cause the one or more processors to perform acts comprising:
facilitating a conversation between a user and another user;
determining a conversation suggestion regarding the conversation based at least in part on a user profile associated with at least one of the user or the other user; and
sending the conversation suggestion to at least one of a computing device of the user or a computing device of the other user.

17. The system of claim 16, wherein the acts further comprise:
monitoring the conversation between the user and the other user to identify one or more interests or characteristics of the other user; and
forming a list of multiple conversation suggestions for the user to use in communicating with the other user based at least in part on the one or more identified interests or characteristics of the other user, the conversation suggestion being one of the multiple conversation suggestions.

18. The system of claim 16, wherein the acts further comprise:
monitoring the conversation between the user and the other user to identify one or more interests or characteristics of the user; and
generating a user profile for the user based at least in part on the one or more interests or characteristics of the user.

19. The system of claim 16, wherein the acts further comprise:
monitoring the conversation between the user and the other user;
determining a conversation metric based at least in part on the monitoring; and
determining that a suggestion event has occurred based at least in part on the conversation metric; and
wherein the conversation suggestion is sent in response to determining the occurrence of the suggestion event.

20. The system of claim 16, wherein the conversation suggestion indicates a topic to discuss during the conversation.
